(19) United States
(12) Patent Application Publication
(10) Pub. No.: US 2021/0263156 A1
(43) Pub. Date: Aug. 26, 2021

(54) CAMERA SYSTEM, VEHICLE AND SENSOR SYSTEM

(71) Applicant: PANASONIC INTELLECTUAL PROPERTY MANAGEMENT CO., LTD., Osaka (JP)

(72) Inventor: Noriyuki TANI, Kanagawa (JP)

(73) Assignee: PANASONIC INTELLECTUAL PROPERTY MANAGEMENT CO., LTD., Osaka (JP)

(21) Appl. No.: 17/318,466

(22) Filed: May 12, 2021

Related U.S. Application Data
(63) Continuation of application No. PCT/JP2019/044198, filed on Nov. 11, 2019.

(30) Foreign Application Priority Data
Nov. 15, 2018 (JP) 2018-214490
Dec. 27, 2018 (JP) 2018-246010

(51) Int. Cl. G01S 17/42; G01S 17/86; G01S 17/58; G01S 7/481; B60R 1/00; B60W 40/06

(52) U.S. Cl. CPC G01S 17/42; G01S 17/86; G01S 17/58; B60R 2300/301; B60R 1/00; B60W 40/06; G01S 7/4817

(57) ABSTRACT

A camera system is mountable on a vehicle body of a vehicle. The camera system includes: a camera; a light beam irradiation device; a processor; and a memory having instructions. The instructions, when executed by the processor, cause the processor to perform operations including: detecting an optical trajectory of a light beam from the light beam irradiation device and captured by the camera; and determining an attachment deviation of the camera based on the optical trajectory. If a size of the optical trajectory is smaller than a predetermined threshold, determination output of the attachment deviation is not performed.

### CROSS-REFERENCE TO RELATED APPLICATIONS

This application is a continuation of PCT International Patent Application No. PCT/JP2019/044198 filed on Nov. 11, 2019, which claims the benefit of priority of Japanese Patent Application No. 2018-214490 filed on Nov. 15, 2018 and Japanese Patent Application No. 2018-246010 filed on Dec. 27, 2018, the entire contents of which are incorporated herein by reference.

### FIELD

The present disclosure relates to a camera system, a vehicle and a sensor system.

### BACKGROUND

A technique for detecting an attachment angle (posture) of a camera or an in-vehicle sensor mounted on a vehicle is disclosed, for example, in JP-A-2018-98715, JP-A-2018-47911, and JP-A-2006-47140.

### SUMMARY

In autonomous driving, a camera attachment angle or an in-vehicle attachment angle is required to have high detection accuracy while controlling cost.

The present disclosure provides a camera system and a vehicle capable of detecting a camera attachment angle with high accuracy. Further, the present disclosure provides a sensor system and a vehicle capable of detecting an in-vehicle sensor attachment angle with high accuracy.

A camera system according to the present disclosure is a camera system mountable on a vehicle body of a vehicle, the camera system including: a camera configured to capture an image; a light beam irradiation device configured to perform irradiation of a light beam; and a detection circuit configured to detect an optical trajectory of the light beam captured by the camera and determine an attachment deviation of the camera based on the optical trajectory, wherein if a size of the optical trajectory is smaller than a predetermined threshold, the detection circuit does not perform determination output of the attachment deviation. Further, a vehicle according to the present disclosure includes the camera system.

A sensor system according to the present disclosure is a sensor system mountable on a vehicle body of a vehicle, the sensor system including: a camera; a light beam irradiation device; an in-vehicle sensor integrally attached to the light beam irradiation device; a processor; and a memory having instructions that, when executed by the processor, cause the processor to perform operations including: detecting an optical trajectory of a light beam from the light beam irradiation device and captured by the camera; and determining an attachment deviation of the in-vehicle sensor based on the optical trajectory, wherein if a size of the optical trajectory is smaller than a predetermined threshold, determination output of the attachment deviation is not performed.

According to the present disclosure, it is possible to detect a camera attachment angle or an in-vehicle attachment angle with high accuracy.

### BRIEF DESCRIPTION OF DRAWINGS

FIG. 1A is a schematic diagram of Related Example 1 according to a camera system of related art.

FIG. 1B is a schematic diagram of Related Example 2 according to a camera system of related art.

FIG. 2A is a side view of an example of a vehicle according to Embodiment 1.

FIG. 2B is a plan view of the example of the vehicle according to Embodiment 1.

FIG. 3A is a schematic side view illustrating an example of a camera visual field and an irradiation region of a camera system according to Embodiment 1.

FIG. 3B is a plan side view illustrating the example of the camera visual field and the irradiation region of the camera system according to Embodiment 1.

FIG. 4 is a block diagram illustrating an example of the camera system according to Embodiment 1.

FIG. 5A is a diagram illustrating an example of determination of a camera attachment deviation according to Embodiment 1, and illustrating a state without attachment deviation.

FIG. 5B is a diagram illustrating an example of determination of a camera attachment deviation according to Embodiment 1, and illustrating a state having attachment deviation.

FIG. 6 is a flowchart illustrating an example of a camera attachment deviation determination output of the camera system according to Embodiment 1.

FIG. 7 is a schematic diagram illustrating an example of a method for detecting an attachment deviation of a rear view camera according to Embodiment 1.

FIG. 8 is a schematic diagram illustrating an example of a method for detecting an attachment deviation of a side camera according to Embodiment 1.

FIG. 9 is a schematic diagram illustrating an example of a method for detecting an attachment deviation when the side camera is attached to or integrated with a door mirror according to Embodiment 1.

FIG. 10 is a schematic diagram showing an example of a method for detecting an attachment deviation of a rear view camera and a side camera according to a visual field of both the rear view camera and the side camera.

FIG. 11A is a schematic diagram of Related Example 1 according to a camera system of related art.

FIG. 11B is a schematic diagram in a case where Related Example 1 is applied to a sensor system.

FIG. 12A is a schematic diagram of Related Example 2 according to a sensor system or related art.

FIG. 12B is a schematic diagram of Related Example 3 according to a camera system of related art.

FIG. 13A is a side view showing an example of a vehicle on which the sensor system of Embodiment 2 is mounted.

FIG. 13B is a plan view of FIG. 13A.

FIG. 14A is a schematic side view illustrating an example of a camera visual field and an irradiation region of the sensor system according to Embodiment 2.

FIG. 14B is a schematic plan view illustrating the example of the camera visual field and the irradiation region of the sensor system according to Embodiment 2.

FIG. 15 is a block diagram illustrating an example of the sensor system according to Embodiment 2.

FIG. 16A is a diagram illustrating an example of determination of an in-vehicle sensor attachment deviation according to Embodiment 2, and illustrating a state without attachment deviation.

FIG. 16B is a diagram illustrating the example of determination of the in-vehicle sensor attachment deviation according to Embodiment 2, and illustrating a state having attachment deviation.

FIG. 17 is a flowchart illustrating an example of an in-vehicle sensor attachment deviation determination output of the sensor system according to Embodiment 2.

FIG. 18 is a schematic diagram illustrating an example of a method for detecting an attachment deviation when the side camera is attached to or integrated with a door mirror according to Embodiment 2.

### DETAILED DESCRIPTION

Hereinafter, embodiments specifically disclosing a camera system, a sensor system, and a vehicle according to the present disclosure will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy in the following description and to facilitate understanding of those skilled in the art. The accompanying drawings and the following description are provided for a thorough understanding of the present disclosure for those skilled in the art, and are not intended to limit the subject matter in the claims.

Hereinafter, preferred embodiments for carrying out the present disclosure will be described in detail with reference to the drawings.

### Embodiment 1

In order to calculate attachment relative angles of cameras mounted on a vehicle with respect to a vehicle body, a method of calculating a difference between absolute angles of the cameras and an absolute angle of the vehicle body is generally used. Methods for acquiring the absolute angle of the vehicle body include: (1) using an inclination angle sensor fixed to the vehicle body; (2) estimating the absolute angle from measurement results of inclination angle sensors mounted on the cameras; and the like. In the case of (1), for real-time detection of a camera attachment angle, it is necessary to simultaneously transmit detection results of the inclination angle sensor fixed to the vehicle body to all the cameras, which increases an occupancy rate of a communication path, loses immediacy of communication content, and deteriorates accuracy of a calculation result of the camera attachment angle. On the other hand, in the case of (2), the same number of inclination angle sensors as the number of cameras are required, which leads to an increase in cost.

More specific methods include: a method of capturing an image of a mark reflected on a windshield with a camera so that a change in posture can be detected with high accuracy based on a difference from coordinates of the mark; and a method of performing control with inclination of a detection value obtained from an acceleration sensor with respect to a straight line on coordinates in auto-leveling.

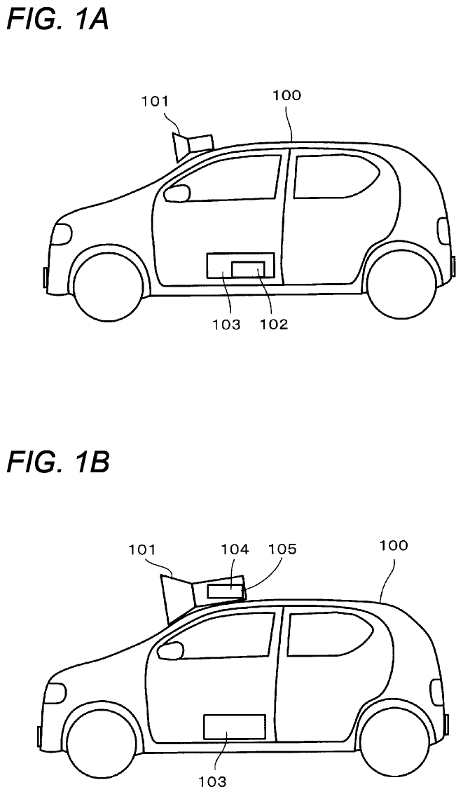

Regarding the camera, as illustrated in FIG. 1A of Related Example 1, a vehicle 100 includes a camera 101, a posture change detector 102, and a controller 103 that integrally controls the entire vehicle such as an ESP and an ECU. The posture change detector 102 calculates a displacement amount (u−u0, v−v0) that is a difference between coordinates (u0, v0) of a mark of an initial posture and coordinates (u, v) acquired by the camera 101, and a displacement direction. That is, the displacement amount and the displacement direction of a current position (measurement position) with respect to an initial position (reference position) are calculated to control the posture of the camera 101.

In other words, an angle estimation of the camera 101 (θvo) is performed by visual odometry, and the attachment angle of the camera 101 is calculated based on a difference from a vehicle posture angle (θCAR) (θCAM=θvo−θCAR). However, when a measurement time of θCAR and an estimation time of θvo are deviated (immediacy is lost), an error of θCAM may be increased, which increases erroneous determination with respect to determination of the camera attachment angle.

Regarding automatic leveling, as illustrated in FIG. 1B of Related Example 2, a vehicle 100 includes the camera 101, an acceleration sensor 104, and the controller 103 that integrally controls the entire vehicle such as an ESP and an ECU. The vehicle posture angle is obtained from the acceleration sensor 104, but for example, the acceleration sensor 104 and an inclination angle sensor 105 may be mounted on the camera 101. The vehicle posture angle (θCAR) is estimated from the acceleration sensor 104 and the inclination angle sensor 105, the angle of the camera 101 (θCARABS) is measured by the inclination angle sensor 105, and based on a difference therebetween, the controller 103 calculates the attachment angle of the camera 101 (θCAM=θCARABS−θCAR). According to this configuration, the inclination angle sensor 105 is required in the camera 101, and when a large number of cameras 101 are mounted on the vehicle 100, the cost is significantly increased.

In a camera system and a vehicle according to the present embodiment in which the above-described problems are solved, the number of mounted inclination angle sensors can be reduced without impairing accuracy of deviation determination of the relative angle of attachment of the camera.

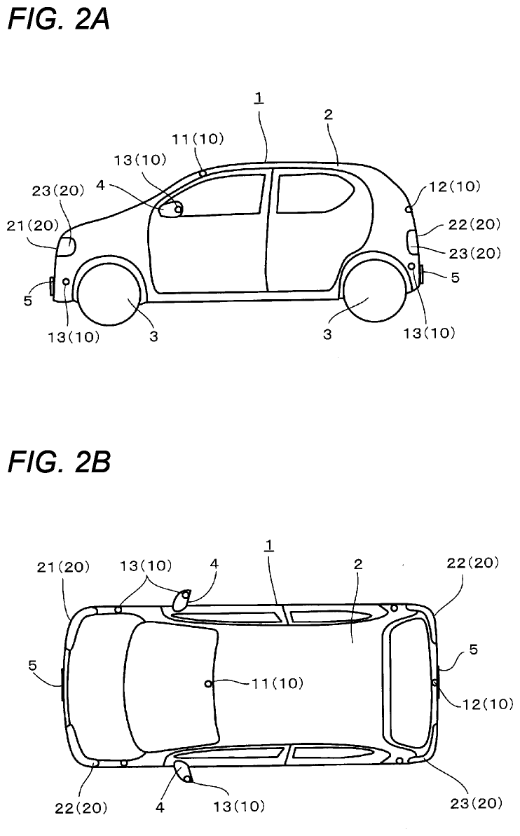

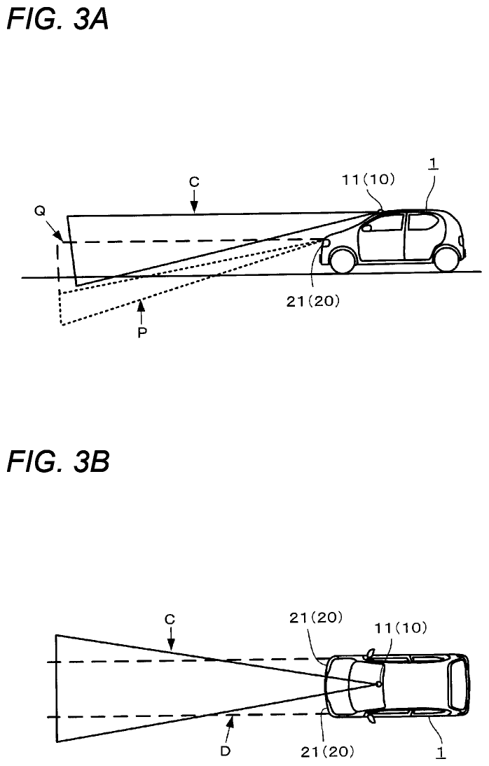

FIGS. 2A and 2B show the vehicle according to the present embodiment, where FIG. 2A is a side view, and FIG. 2B is a plan view. FIGS. 3A and 3B are schematic diagrams illustrating a camera visual field and an illumination region of the camera system of the present embodiment, where FIG. 3A is a side view, and FIG. 3B is a plan view. As shown in the drawings, the embodiment of the vehicle is exemplified by an automobile that can automatically travel among automobiles as set forth in Road Transport Vehicle Act of Japan. The vehicle is capable of autonomous traveling (autonomous driving) such as forward traveling, backward traveling, right/left turning, and U-turn.

The vehicle 1 has a vehicle body 2 and wheels 3 constituting the vehicle 1. Door mirrors 4 are attached to lateral sides of the vehicle body 2, and license plates 5 are attached to front and rear sides of the vehicle body 2. In addition, the vehicle 1 is mounted with cameras 10 capable of capturing an image and a light beam irradiation device 20 that perform irradiation of a light beam.

The cameras 10 include a front camera 11 that captures an image of the front of the vehicle 1, but may also include a rear view camera 12 that captures an image of the rear of the vehicle 1 and is attached to the rear side of the vehicle body 2, and side cameras 13 that capture an image of lateral sides of the vehicle 1 and are attached to the lateral sides of the vehicle body 2. The rear view camera 12 is attached to a center position in the vehicle width, for example, above the license plate 5. The side cameras 13 may be attached to the door mirrors 4, and may be obtained by turning door mirrors that capture an image of the visual field range of the door mirrors 4 into cameras (for example, CMS: camera monitoring system).

The light beam irradiation device 20 includes first light beam irradiation devices 21 that irradiate the front of the vehicle 1, second light beam irradiation devices 22 that irradiate the rear of the vehicle 1, and third light beam irradiation devices 23 that irradiate the lateral sides of the vehicle 1. The light beam irradiation device 20 forms a light distribution pattern P defined by a safety standard as set forth in Road Transport Vehicle Act of Japan by using a light beam emitted from a light source (not shown), but may also include, for example, an infrared ray irradiation device using a laser beam as the light source and may have an irradiation pattern Q for performing irradiation of a light beam having high straightness.

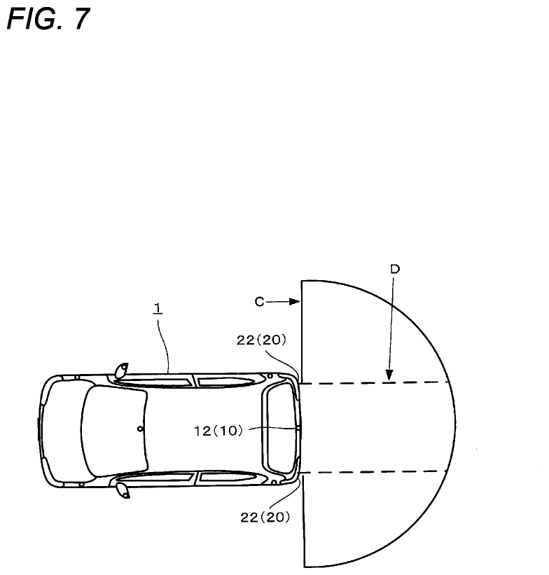

In FIGS. 3A and 3B, C indicated by a solid line in the drawings is a camera visual field, and D indicated by a broken line in the drawings is an irradiation region that is a combination of the light distribution pattern P and the irradiation pattern Q. Hereinafter, the same applies to FIGS. 7 to 10.

Each first light beam irradiation device 21 is a headlamp (headlight), a fog lamp, a clearance lamp, or the like. Each second light beam irradiation device 22 is a tail lamp, a stop lamp, a back lamp, or the like. Each third light beam irradiation device 23 is a side lamp, a turn signal lamp, or the like.

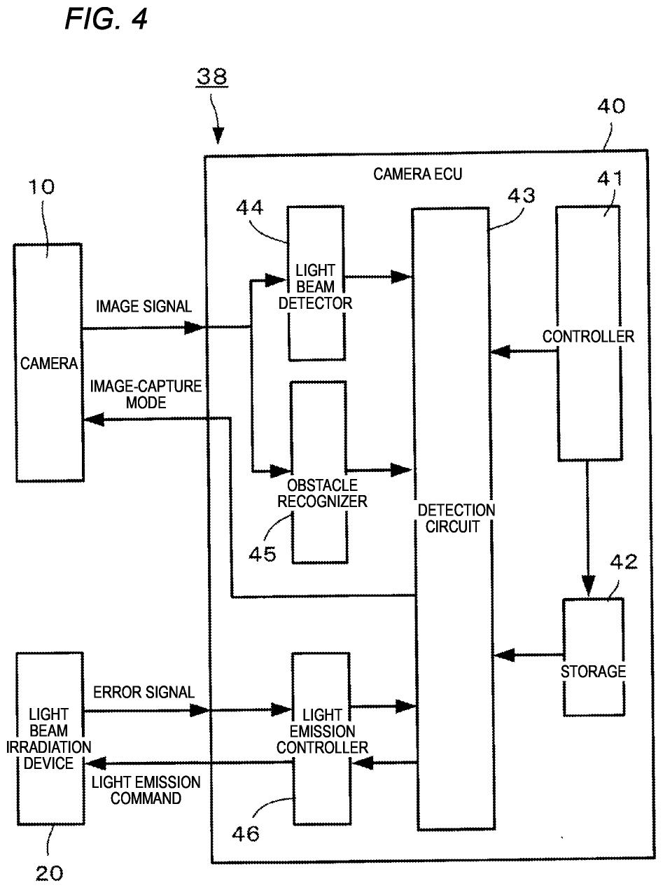

FIG. 4 is a block diagram of a camera system. The camera system according to the present embodiment will be described with reference to FIG. 4.

The camera system 38 of the present embodiment is mounted on the vehicle 1, and includes the camera 10, the light beam irradiation device 20, and a camera ECU 40. The camera ECU 40 includes, for example, a processor and a memory. In the present embodiment, the camera ECU 40 includes a controller 41 such as a CPU, a storage 42, a detection circuit 43, a light beam detector 44, an obstacle recognizer 45, and a light emission controller 46.

The controller 41 controls the entire camera system 38. The storage 42 stores information such as a template prepared in advance and images captured by the camera 10. The light beam detector 44 detects an optical trajectory of a light beam captured by the camera 10. The obstacle recognizer 45 recognizes an obstacle or the like from an image captured by the camera 10. The detection circuit 43 determines the attachment deviation of the camera 10 based on the optical trajectory of the light beam detected by the light beam detector 44, and controls an image-capture mode with respect to the camera 10. The camera 10 captures an image based on the image-capture mode, and the captured image is converted into an image signal and transmitted to the light beam detector 44 and the obstacle recognizer 45. The light emission controller 46 controls on and off of the light beam irradiation device 20, and for example, issues a light emission command to the light beam irradiation device 20 and receives an error signal or the like from the light beam irradiation device 20.

The light beam radiated by the light beam irradiation device 20 includes any arbitrary optical pattern, a highly linear laser beam radiated from a laser diode or the like, and the like, and also includes a predetermined light beam pattern of a light beam radiated by a light source such as a near-infrared ray incorporated in a headlamp or the like. The near infrared irradiation is effective when difficult to be detected from the light distribution pattern P formed by visible light, such as in the daytime.

In addition, a light detection and ranging (LIDAR), a millimeter wave radar, or the like may be provided. The LIDAR emits a light beam (for example, an infrared ray laser) around the vehicle 1, receives a reflection signal thereof, and measures, based on the received reflection signal, a distance to an object present in the surroundings, a size of the object, and a composition of the object. The millimeter wave radar radiates a radio wave (millimeter wave) around the vehicle 1, receives a reflected signal thereof, and measures, based on the received reflected signal, a distance to an object present in the surroundings. The millimeter wave radar can detect a distant object that is difficult to detect by the LIDAR as well.

The optical trajectory necessary for determining the attachment deviation of the camera 10 is an optical pattern that is a pattern of a reflected light obtained by irradiating an irradiation object with the light beam, and is also a light beam trajectory that is a trajectory through which the light beam passes.

The light beam irradiation device 20 may include an inclination angle sensor. The inclination angle sensor can normally estimate the inclination angle of the camera 10 with respect to the vehicle body 2, and can prevent in advance erroneous detection of the angle deviation of the camera 10 due to the angle deviation of the irradiation direction.

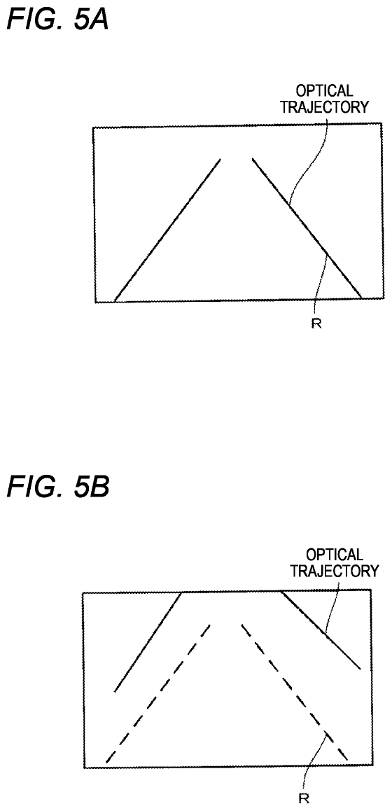

FIGS. 5A and 5B are schematic diagrams illustrating an example of a camera attachment deviation determination output, where FIG. 5A illustrates a state without attachment deviation, and FIG. 5B illustrates a state having attachment deviation. The example of the camera attachment deviation determination will be described with reference to FIGS. 5A and 5B.

As illustrated in FIGS. 5A and 5B, in order to determine the attachment deviation of the camera 10, a white line R, which is an example of an optical trajectory drawn on a road surface, is used. Upon determination, it is desirable to select a road surface on which the white line R is a straight line. Reflected light (optical pattern) obtained by irradiating an appropriate irradiation object such as the white line R is captured by the camera 10, an optical trajectory is detected from the captured image, and a position and an angle of the optical trajectory (for example, the white line R) are detected. The detection result is compared with a position and an angle of the template or the like stored in the storage 42.

FIG. 5A shows a case where the optical trajectory (white line R) and the template coincide with each other, and FIG. 5B shows a case where the optical trajectory (solid line) and the template (broken line) do not coincide with each other. If the position and the angle are appropriate, it is determined that there is no attachment deviation of the camera 10, and if equal to or greater than the threshold, it is determined that there is attachment deviation.

The pattern of the reflected light from the white line R in front of the vehicle 1 varies depending on various conditions of the road such as the shape of the white line R and an inter-vehicle distance, and thus is not necessarily obtained appropriately. Therefore, more accurate information on the white line R can be acquired due to an irradiation pattern Q obtained with a linear light beam. In addition, since the first light beam irradiation devices 21 are normally a pair of right and left, the accuracy of information on the position and angle of the white line R captured by the camera 10 (the front camera 11) is improved.

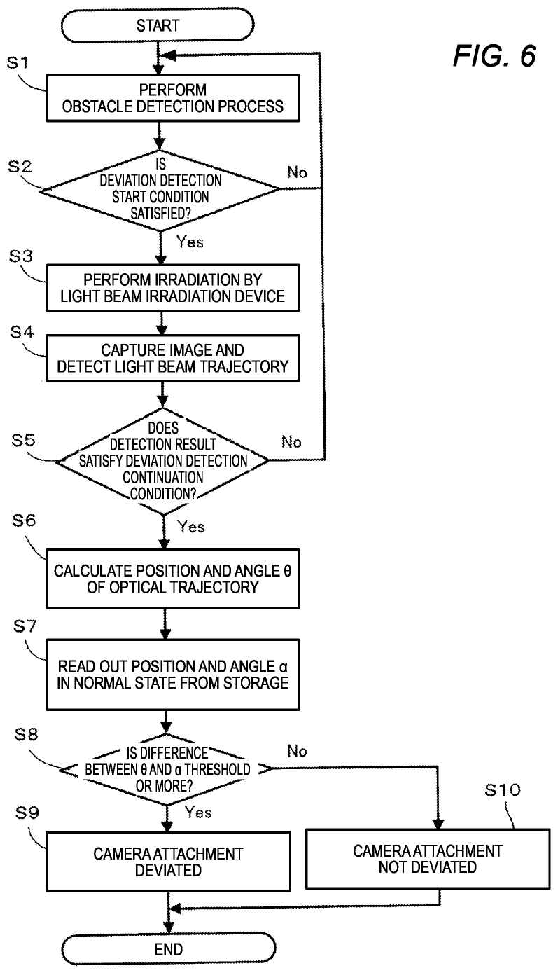

FIG. 6 is a flowchart showing the determination of the attachment deviation of the camera 10. An example of the attachment deviation determination of the camera 10 will be described with reference to FIG. 6.

The obstacle recognizer 45 performs an obstacle detection process based on the image captured by the camera 10 (step S1). The obstacle detection process is a step of determining whether an object that may block the light beam is detected within a predetermined distance from the camera 10, and corresponds to a basic execution condition as a basic premise in a subsequent determination of whether a deviation detection start condition is satisfied (step S2).

However, if the attachment deviation detection of the camera 10 is performed each time the basic condition is satisfied, the attachment deviation detection process of the camera 10 is frequently executed, which may adversely affect the life of the light beam irradiation device 20 or the like. Here, the following additional conditions may be added to the basic execution condition as the deviation detection start condition of step S2.

(1) Execution conditions: conditions related to timing, situation, and the like under which it is preferable to perform detection.

a. Within a predetermined time immediately after the vehicle 1 is started (ignition on, etc.)

b. After elapse of a predetermined time from execution of previous deviation detection

c. Immediately after an impact is applied to the vehicle 1

d. When an image of an object is captured within a predetermined distance from the camera 10 (possibility of collision)

(2) Non-execution conditions: conditions related to timing, situation, and the like under which it is preferable to not perform detection.

a. Steering at a predetermined angle or more (the light beam is likely to travel in a direction in which an obstacle is present, and it is difficult to obtain a stable optical trajectory)

b. A slope present at a predetermined distance ahead (the camera 10 and the light beam irradiation device 20 may be inclined)

c. When the road surface is bumpy (the road surface condition is poor and it is difficult to obtain a stable optical trajectory)

d. When the road surface is wet (the road surface condition is poor and it is difficult to obtain a stable optical trajectory)

e. When the road surface is covered with snow (the road surface condition is poor and it is difficult to obtain a stable optical trajectory)

When it is determined that any deviation detection start condition is satisfied (Yes in step S2), the light beam irradiation device 20 is turned on to radiate a light beam (step S3). When it is determined that no deviation detection start conditions are satisfied (No in step S2), the deviation detection is not performed. For example, in a case where the camera 10 captures an image of an object that is present within a predetermined range of distance from the camera 10 and that is likely to block the light beam, the detection circuit 43 does not perform the determination output of the attachment deviation.

Next, an image of a light beam trajectory of the light beam is captured by the camera 10, and is detected by the detection circuit 43 (step S4). Then, the detection circuit 43 determines whether the detection result satisfies a deviation detection continuation condition (step S5).

The determination in step S5 is performed based on whether a length of the detected optical trajectory (optical pattern, light beam trajectory) is equal to or greater than a predetermined length. When the size of the optical trajectory is larger than a predetermined threshold (Yes in step S5), the detection circuit 43 calculates a position and an angle θ of the optical trajectory (for example, the white line R) (step S6).

When the size of the optical trajectory is smaller than the predetermined threshold (No in step S5), the detection circuit 43 does not perform determination output of the attachment deviation starting from step S6.

However, in the case of detecting the optical trajectory, since the optical trajectory is reflection from the object and thus may be likely to be affected by external factors, the condition may be made strict, and whether a degree of coincidence (likelihood) between the size (length) of the detected optical trajectory and the size (length) of a template prepared in advance (for example, a template of a white line on a road) is equal to or greater than a predetermined value may be added to the condition (the condition is satisfied as long as the degree of coincidence is equal to or greater than the predetermined value).

Further, in the case of detecting the light beam trajectory, since the light beam trajectory is basically a trajectory of a light beam traveling in the air and is unlikely to be affected by external factors, the condition may be set looser than the optical trajectory, and the condition may be set to be whether a length a the line segment of the detected light beam trajectory is equal to or less than a predetermined value (for example, the condition is satisfied as long as the optical trajectory of the laser light traveling straight is equal to or more than the predetermined length).

Next, the detection circuit 43 reads out a position and an angle α in a normal state like a template from the storage 42 (step S7), and performs determination output of the attachment deviation of the camera 10. That is, it is determined whether a difference between the angle α and the angle θ is equal to or greater than a threshold (step S8).

In a situation where the detection circuit 43 is performing the determination output of the attachment deviation, when the size of the optical trajectory becomes smaller than a predetermined threshold, the detection circuit 43 interrupts the determination output of the attachment deviation. As a result, it is possible to prevent erroneous determination of the determination output.

When the detection circuit 43 determines that the difference between the angle α and the angle θ is equal to or larger than the threshold (Yes in step S8), the detection circuit 43 determines that attachment deviation occurs to the camera 10 (step S9). When the detection circuit 43 determines that the difference between the angle α and the angle θ is not equal to or larger than the threshold (No in step S8), the detection circuit 43 determines that attachment deviation does not occur to the camera 10 (step S10).

Since the optical trajectory is detected from the image captured by the camera 10 and compared with the template or the like stored in the storage 42 so as to determine the attachment deviation of the camera 10, it is possible to detect the attachment deviation (optical axis deviation) of the camera 10 at low cost without impairing the determination accuracy of the attachment deviation determination output.

Although the attachment deviation determination output of the camera 10 has been described with reference to the front camera 11, the same applies to the rear view camera 12 and the side cameras 13.

FIG. 7 shows a method for detecting an attachment deviation of the rear view camera 12 that captures an image of the rear of the vehicle 1. The detection circuit 43 uses irradiation by the second light beam irradiation devices 22 that irradiate the rear of the vehicle 1 to detect an optical trajectory of a light beam captured by the rear view camera 12 (for example, the white line R), and performs determination output of attachment deviation of the rear view camera 12.

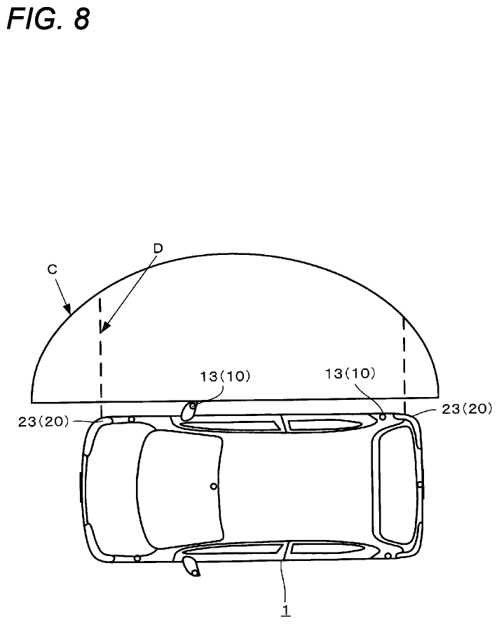

FIG. 8 shows a method for detecting an attachment deviation of the side cameras 13 that capture an image of the lateral sides of the vehicle 1. The detection circuit 43 uses irradiation by the third light beam irradiation devices 23 that irradiate the lateral sides of the vehicle 1 to detect an optical trajectory of a light beam captured by the side cameras 13 (for example, the white line R), and performs determination output of attachment deviation of the side cameras 13. The lateral irradiation is mainly performed by a side lamp, a turn signal lamp, and the like as the third light beam irradiation devices 23, but may also include irradiation from left and right ends of the first light beam irradiation devices 21.

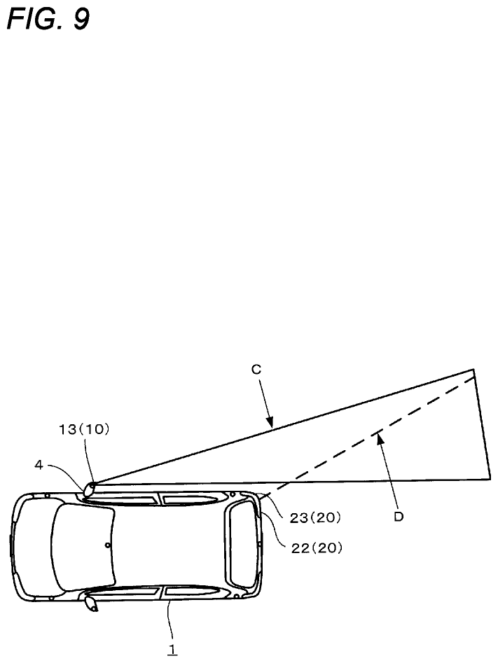

FIG. 9 shows a method for detecting the attachment deviation of the side camera 13 when the side camera 13 is attached to or integrated with the door mirror 4. The detection circuit 43 uses irradiation by the third light beam irradiation device 23 that irradiate the lateral side of the vehicle 1 and the second light beam irradiation device (for example, tail lamp) 22 that irradiates the rear of the vehicle 1 to detect an optical trajectory of a light beam captured by the side camera 13 (for example, the white line R), and performs determination output of attachment deviation of the side camera 13.

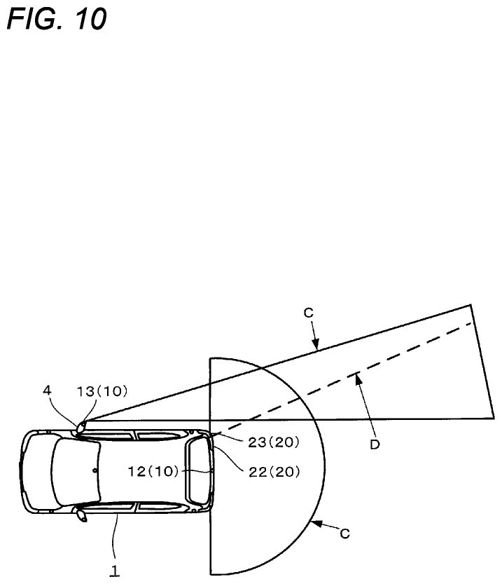

FIG. 10 shows a method for detecting the attachment deviation of the rear view camera 12 and the side camera 13 according to a visual field C of both the rear view camera 12 and the side camera 13. Using an irradiation region D of the second light beam irradiation device 22 and the third light beam irradiation device 23, the detection circuit 43 determines the attachment deviation of the rear view camera 12 and the side camera 13 by comparing the optical trajectory of the light beam captured by the rear view camera 12 with the optical trajectory of the light beam captured by the side camera 13. Accordingly, it is possible to detect whether attachment deviation occurs to either one of the rear view camera 12 and the side camera 13 even without using an inclination angle sensor for the second light beam irradiation device 22 or the third light beam irradiation device 23.

According to the above disclosure, since the camera attachment deviation determination output is performed based on the optical trajectory of the light beam captured by the camera, it is possible to reduce the number of mounted inclination angle sensors and to detect the optical axis deviation of the camera at low cost without impairing the determination accuracy. In addition, since the predetermined threshold is provided for the optical trajectory, it is possible to prevent erroneous determination.

An embodiments of the camera system and the vehicle have been described above with reference to the drawings, but the present embodiment is not limited thereto. It will be apparent to those skilled in the art that various alterations, modifications, substitutions, additions, deletions, and equivalents can be conceived within the scope of the claims, and it should be understood that such changes also belong to the technical scope of the present disclosure.

### Summary of Embodiment 1

Embodiment 1 has the following features.

(Feature 1) A camera system mountable on a vehicle body of a vehicle, the camera system including:

a camera configured to capture an image;

a light beam irradiation device configured to perform irradiation of a light beam; and

a detection circuit configured to detect an optical trajectory of the light beam captured by the camera and determine an attachment deviation of the camera based on the optical trajectory,

wherein if a size of the optical trajectory is smaller than a predetermined threshold, the detection circuit does not perform determination output of the attachment deviation.

(Feature 2)

The camera system according to Feature 1,

wherein in a situation where the detection circuit is performing the determination output of the attachment deviation, if the size of the optical trajectory becomes smaller than a predetermined threshold, the detection circuit interrupts the determination output of the attachment deviation.

(Feature 3)

The camera system according to Feature 1 or 2,

wherein in a case where the camera captures an image of an object that is present within a predetermined range of distance from the camera and that is likely to block the light beam, the detection circuit does not perform the determination output of the attachment deviation.

(Feature 4)

The camera system according to any one of Features 1 to 3,

wherein the optical trajectory is an optical pattern that is a pattern of a reflected light obtained by irradiating an irradiation object with the light beam.

(Feature 5)

The camera system according to any one of Features 1 to 3,

wherein the optical trajectory is a light beam trajectory that is a trajectory through which the light beam passes.

(Feature 6)

The camera system according to any one of Features 1 to 5,

wherein the camera is at least one of: a front camera attached to a front side of the vehicle body; a rear view camera attached to a rear side of the vehicle body; and a side camera attached to a lateral side of the vehicle body.

(Feature 7)

The camera system according to Feature 6,

wherein the camera includes the rear view camera and the side camera, and

wherein the detection circuit is configured to determine the attachment deviation of the camera by comparing the optical trajectory of the light beam captured by the rear view camera with the optical trajectory of the light beam captured by the side camera.

(Feature 8)

A vehicle including the camera system according to any one of Features 1 to 7.

### Embodiment 2

### Problems of Related Art

In order to calculate attachment relative angles of in-vehicle sensors mounted on a vehicle with respect to a vehicle body, a method of calculating a difference between absolute angles of the in-vehicle sensors and an absolute angle of the vehicle body is generally used. Methods for acquiring the absolute angle of the vehicle body include: (1) using an inclination angle sensor fixed to the vehicle body; (2) estimating the absolute angle from measurement results of inclination angle sensors mounted on the in-vehicle sensors; and the like. In the case of (1), the same number of inclination angle sensors as the number of in-vehicle sensors are required. It is necessary to simultaneously transmit detection results of the inclination angle sensor fixed to the vehicle body to all the in-vehicle sensors, which increases an occupancy rate of a communication path, loses immediacy of communication content, and deteriorates accuracy of a calculation result of the in-vehicle sensor attachment (relative) angle. On the other hand, in the case of (2), the same number of inclination angle sensors and acceleration sensors as the number of in-vehicle sensors are required, which leads to an increase in cost.

Separately from this, the related art proposes a method of using a detection result of an in-vehicle sensor itself (reflected wave reception level or the like) to detect an execution timing of an attachment angle deviation detection process. However, in the related method, when attachment deviation has already occurred to the in-vehicle sensor, it is not possible to determine the correct execution timing of the detection process, which leads to erroneous determination of attachment deviation.

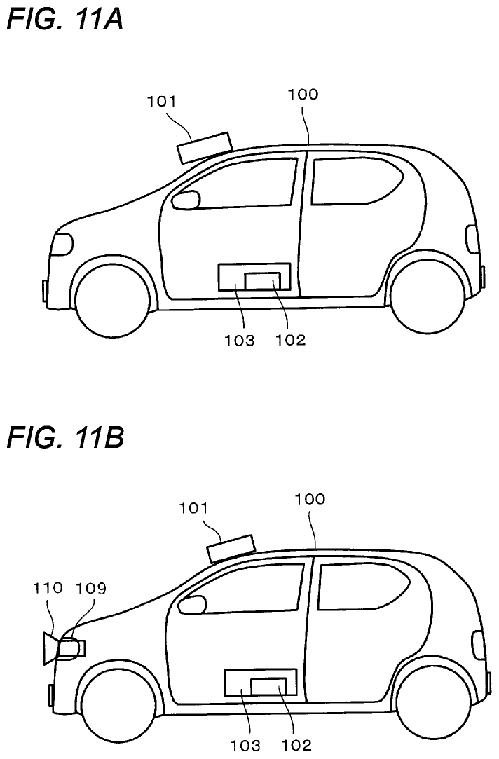

Regarding the camera, as illustrated in FIG. 11A of Related Example 1, the vehicle 100 includes the camera 101, the posture change detector 102, and the controller 103 that integrally controls the entire vehicle such as an ESP and an ECU. The posture change detector 102 calculates the displacement amount (u−u0, v−v0) that is the difference between coordinates (u0, v0) of the mark of the initial posture and the coordinates (u, v) acquired by the camera 101, and the displacement direction. That is, the displacement amount and the displacement direction of the current position (measurement position) with respect to the initial position (reference position) are calculated to control the posture of the camera 101.

Related Example 1 can also be applied to posture control of an in-vehicle sensor 110 integrally attached to the light beam irradiation device 109. In the vehicle 100 illustrated in FIG. 11B, the light beam irradiation device 109 is provided with the in-vehicle sensor 110, and the posture change detector 102 is also an inclination angle sensor. Angle measurement of the in-vehicle sensor 110 (θSABS) is performed by the posture change detector 102 which is an inclination angle sensor, and an attachment angle of the in-vehicle sensor 110 (relative to the vehicle body) is calculated based on a difference from the vehicle posture angle (θCAR) (θSrel=θSABS−θCAR). However, when a measurement time of θCAR and an estimation time of θSABS are deviated (immediacy is lost), an error of an in-vehicle sensor angle θCAM may be increased, which increases erroneous determination with respect to attachment deviation determination of the in-vehicle sensor 110.

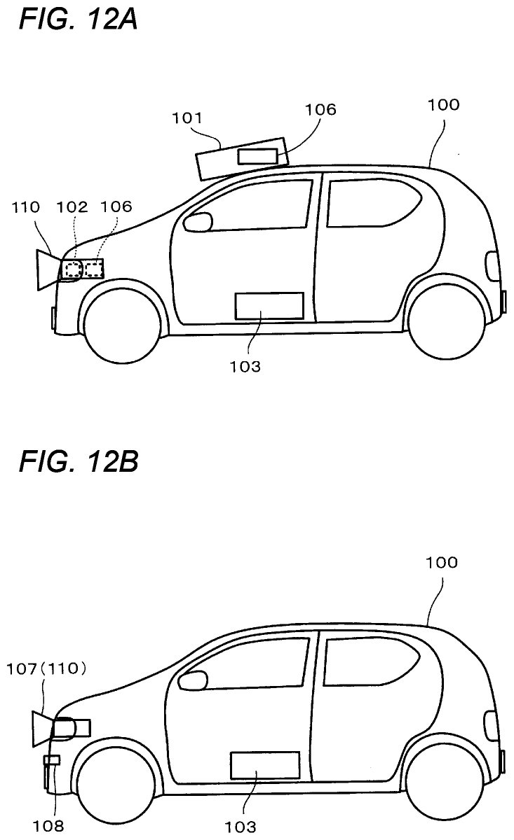

Regarding automatic leveling, as illustrated in FIG. 12A of Related Example 2, a vehicle 100 includes the camera 101, an acceleration sensor 106, and the controller 103 that integrally controls the entire vehicle such as an ESP and an ECU. The vehicle posture angle is obtained from the acceleration sensor 106, but for example, the acceleration sensor 106 and the posture change detector 102 may be mounted on the in-vehicle sensor 110. The vehicle posture angle (θCAR) is estimated from the acceleration sensor 106 and the posture change detector 102, the angle of the in-vehicle sensor 110 (θSABS) is measured by the posture change detector 102, and based on a difference therebetween, the controller 103 calculates the attachment (relative) angle of the in-vehicle sensor 110 (θSrel=θSABS−θCAR). According to this configuration, the acceleration sensor 106 is required in the in-vehicle sensor 110, and when a large number of in-vehicle sensors 110 are mounted on the vehicle 100, the cost is significantly increased.

In Related Example 3, as illustrated in FIG. 12B, a laser device 107 and a minute reflective member 108 are attached to the front side of the vehicle 100. Reference data relating to the minute reflective member 108 is compared with data at the time of use, and when a comparison result exceeds a predetermined value, it is determined that there is an axial deviation of the laser device 107. However, when the in-vehicle sensor 110 such as the laser device 107 and the minute reflective member 108 are deviated together in the same manner, the angle deviation cannot not detected. Further, when the in-vehicle sensor 110 and the minute reflective member 108 are integrally attached, the in-vehicle sensor 110 and the minute reflective member 108 are deviated together, and as a result, the deviation cannot be detected.

In a sensor system and a vehicle according to the present embodiment in which the above-described problems of the related art are solved, the number of mounted inclination angle sensors can be reduced without impairing accuracy of deviation determination of the relative angle of attachment of the in-vehicle sensor.

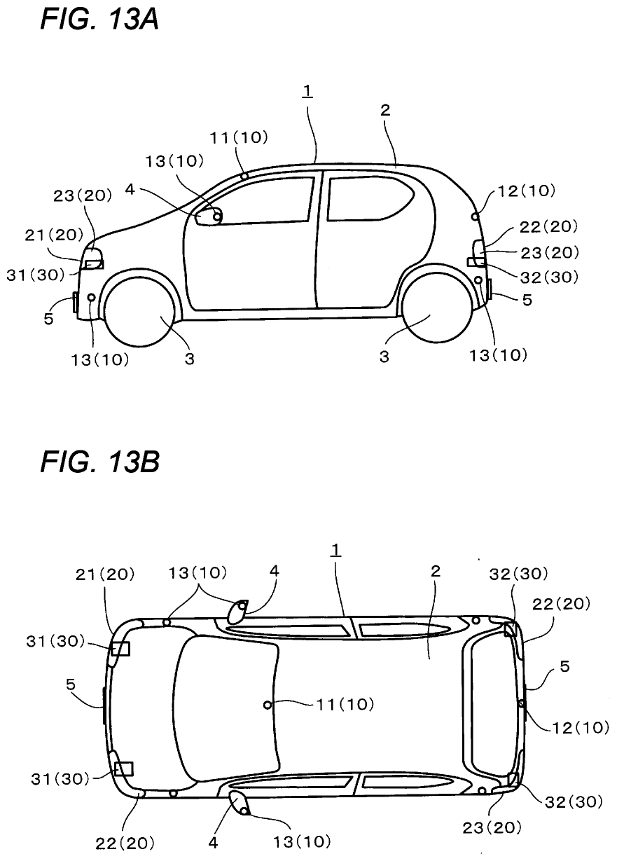

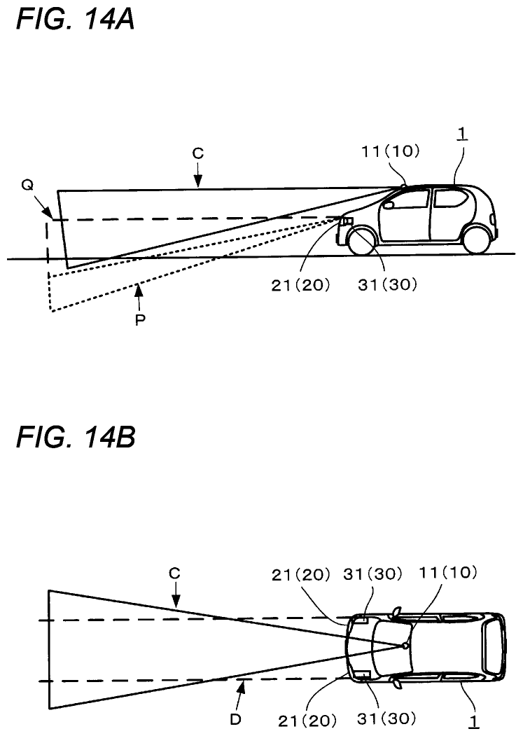

FIGS. 13A and 13B show the vehicle according to the present embodiment, where FIG. 13A is a side view, and FIG. 13B is a plan view. FIGS. 14A and 14B are schematic diagrams illustrating a camera visual field and an illumination region of the sensor system of the present embodiment, where FIG. 14A is a side view, and FIG. 14B is a plan view. As shown in the drawings, the embodiment of the vehicle is exemplified by an automobile that can automatically travel among automobiles as set forth in Road Transport Vehicle Act of Japan. The vehicle is capable of autonomous traveling (autonomous driving) such as forward traveling, backward traveling, right/left turning, and U-turn.

The vehicle 1 has the vehicle body 2 and the wheels 3 constituting the vehicle 1. The door mirrors 4 are attached to the lateral sides of the vehicle body 2, and the license plates 5 are attached to the front and rear sides of the vehicle body 2. In addition, the vehicle 1 is mounted with the cameras 10 capable of capturing an image, the light beam irradiation device 20 that performs irradiation of a light beam, and in-vehicle sensors 30.

The cameras 10 include the front camera 11 that captures an image of the front of the vehicle 1, but may also include the rear view camera 12 that captures an image of the rear of the vehicle 1 and is attached to the rear side of the vehicle body 2, and the side cameras 13 that capture an image of the lateral sides of the vehicle 1 and are attached to the lateral sides of the vehicle body 2. The rear view camera 12 is attached to the center position in the vehicle width, for example, above the license plate 5. The side cameras 13 may be attached to the door mirrors 4, and may be obtained by turning door mirrors that capture an image of the visual field range of the door mirrors 4 into cameras (for example, CMS: camera monitoring system).

The light beam irradiation device 20 includes the first light beam irradiation devices 21 that irradiate the front of the vehicle 1, the second light beam irradiation devices 22 that irradiate the rear of the vehicle 1, and the third light beam irradiation devices 23 that irradiate the lateral sides of the vehicle 1. The light beam irradiation device 20 forms the light distribution pattern P defined by the safety standard as set forth in Road Transport Vehicle Act of Japan by using a light beam emitted from a light source (not shown), but may also include, for example, an infrared ray irradiation device using a laser beam as the light source and may have an irradiation pattern Q for performing irradiation of a light beam having high straightness.

The in-vehicle sensors 30 radiate waves to measure a distance to the irradiation object. Examples thereof include a light detection and ranging (LIDAR), a millimeter wave radar, and a sonar. The in-vehicle sensors 30 include first in-vehicle sensors 31 integrally attached to the first light beam irradiation devices 21 and second in-vehicle sensors 32 integrally attached to the second light beam irradiation devices 22. In addition, third in-vehicle sensors integrally attached to the third light beam irradiation devices 23 may also be provided.

The LIDAR emits a light beam (for example, an infrared ray laser) around the vehicle 1, receives a reflection signal thereof, and measures, based on the received reflection signal, a distance to an irradiation object present in the surroundings, a size of the irradiation object, and a composition of the irradiation object. The millimeter wave radar radiates a radio wave (millimeter wave) around the vehicle 1, receives a reflected signal thereof, and measures, based on the received reflected signal, a distance to an irradiation object present in the surroundings. The millimeter wave radar can detect a distant object that is difficult to detect by the LIDAR as well. The sonar radiates a sound wave around the vehicle 1, receives a reflected signal thereof, and measures, based on the received reflected signal, a distance to an irradiation object present in the surroundings. The sonar can detect an accurate distance of an irradiation object in the vicinity of the vehicle 1.

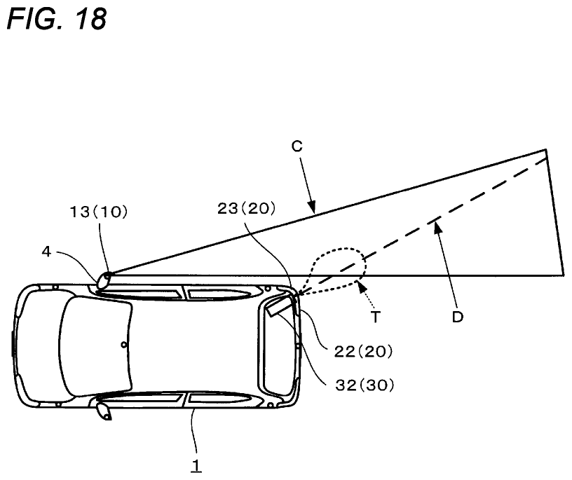

In FIGS. 14A and 14B, C indicated by a solid line in the drawings is a camera visual field, and D indicated by a broken line in the drawings is an irradiation region that is a combination of the light distribution pattern P and the irradiation pattern Q. Hereinafter, the same applies to FIG. 18.

Each first light beam irradiation device 21 is a headlamp (headlight), a fog lamp, a clearance lamp, or the like. Each second light beam irradiation device 22 is a tail lamp, a stop lamp, a back lamp, or the like. Each third light beam irradiation device 23 is a side lamp, a turn signal lamp, or the like.

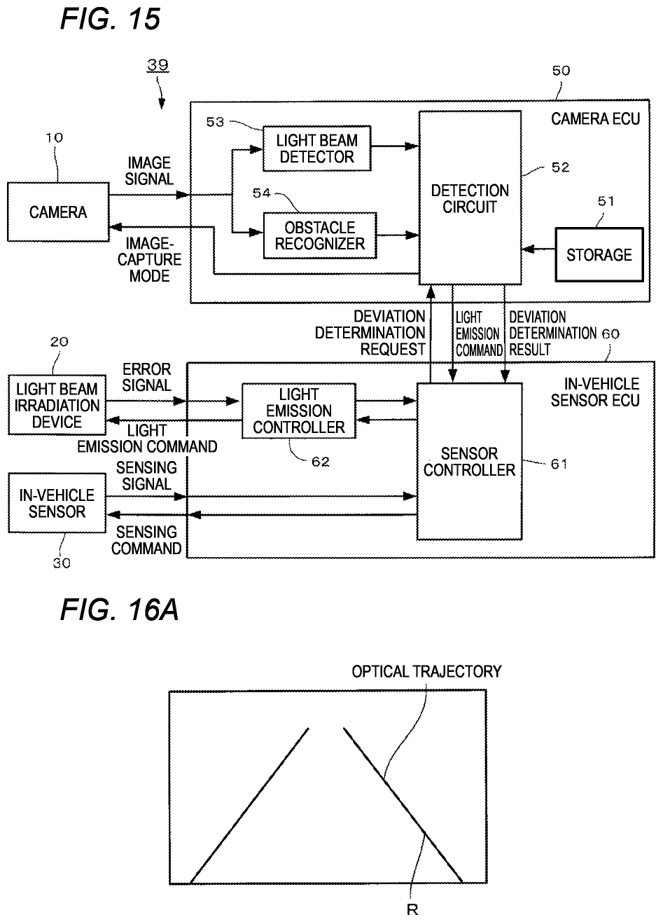

FIG. 15 is a block diagram of a sensor system. The sensor system according to the present embodiment will be described with reference to FIG. 15.

A sensor system 39 of the present embodiment is mounted on the vehicle 1, and includes the camera 10, the light beam irradiation device 20, an in-vehicle sensor 30, a camera ECU 50, and an in-vehicle sensor ECU 60. Each of the camera ECU 50 and the in-vehicle sensor ECU 60 includes, for example, a processor and a memory. In the present embodiment, the camera ECU 50 includes a storage 51, a detection circuit 52, a light beam detector 53, and an obstacle recognizer 54. The in-vehicle sensor ECU 60 includes a sensor controller 61 and a light emission controller 62.

The camera ECU 50 is connected to the camera 10, receives an image signal from the camera 10, and issues an image-capture command to the camera 10. The in-vehicle sensor ECU 60 is connected to the light beam irradiation device 20 and the in-vehicle sensor 30, and transmits and receives signals. The camera ECU 50 and the in-vehicle sensor EUC 60 are connected to each other to transmit and receive a light emission command and a deviation detection signal.

The storage 51 of the camera ECU 50 stores information such as a template prepared in advance and images captured by the camera 10. The detection circuit 52 determines the attachment deviation of the in-vehicle sensor 30. The light beam detector 53 detects an optical trajectory of a light beam captured by the camera 10. The obstacle recognizer 54 recognizes an obstacle or the like from an image captured by the camera 10. The detection circuit 52 determines the attachment deviation of the in-vehicle sensor 30 based on the optical trajectory of the light beam detected by the light beam detector 44, and issues an image-capture command with respect to the camera 10. The camera 10 captures an image based on the image-capture command, and the captured image is converted into an image signal and transmitted to the light beam detector 53 and the obstacle recognizer 54.

The sensor controller 61 of the in-vehicle sensor ECU 60 issues a sensing command to the in-vehicle sensor 30, and receives a sensing signal obtained based on the sensing command. The light emission controller 62 sends a light emission command to the light beam irradiation device 20, receives an error signal from the light beam irradiation device 20, and controls on and off of the light beam irradiation device 20.

The detection circuit 52 and the sensor controller 61 transmit and receive information in order to determine the attachment deviation of the in-vehicle sensor 30. For example, the sensor controller 61 instructs the detection circuit 52 to determine deviation of the in-vehicle sensor 30, and the detection circuit 52 determines deviation of the in-vehicle sensor 30 based on information of the camera 10 and transmits the deviation determination result to the sensor controller 61. The detection circuit 52 also issues a light emission command of the light beam irradiation device 20 to the sensor controller 61.

The light beam radiated by the light beam irradiation device 20 includes any arbitrary optical pattern, a highly linear laser beam radiated from a laser diode or the like, and the like, and also includes a predetermined light beam pattern of a light beam radiated by a light source such as a near-infrared ray incorporated in a headlamp or the like. The near infrared irradiation is effective when difficult to be detected from the light distribution pattern P formed by visible light, such as in the daytime.

The optical trajectory necessary for determining the attachment deviation of the in-vehicle sensor 30 is an optical pattern that is a pattern of a reflected light obtained by irradiating an irradiation object with the light beam, and is also a light beam trajectory that is a trajectory through which the light beam passes.

The light beam irradiation device 20 may include an inclination angle sensor. The inclination angle sensor can normally estimate the inclination angle of the in-vehicle sensor 30 with respect to the vehicle body 2, and can prevent in advance erroneous detection of the angle deviation of the in-vehicle sensor 30 due to the angle deviation of the irradiation direction.

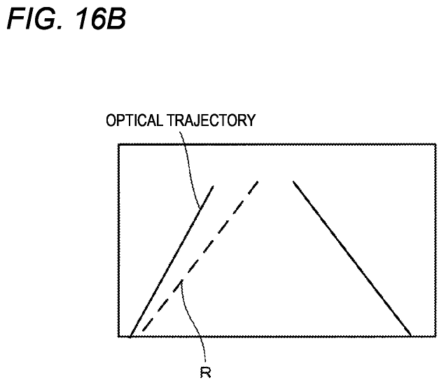

FIGS. 16A and 16B are schematic diagrams illustrating an example of an in-vehicle sensor attachment deviation determination output, where FIG. 16A illustrates a state without attachment deviation, and FIG. 16B illustrates a state having attachment deviation. The example of the in-vehicle sensor attachment deviation determination will be described with reference to FIGS. 16A and 16B.

As illustrated in FIGS. 16A and 16B, in order to determine the attachment deviation of the in-vehicle sensor 30, a white line R, which is an example of an optical trajectory drawn on a road surface, is used. Upon determination, it is desirable to select a road surface on which the white line R is a straight line Reflected light (optical pattern) obtained by irradiating an appropriate irradiation object such as the white line R is captured by the camera 10, an optical trajectory is detected from the captured image, and a position and an angle of the optical trajectory (for example, the white line R) are detected. The detection result is compared with a position and an angle of the template or the like stored in the storage 51.

FIG. 16A shows a case where the optical trajectory (white line R) and the template coincide with each other, and FIG. 16B shows a case where the optical trajectory (solid line) and the template (broken line) do not coincide with each other. If the position and the angle are appropriate, it is determined that there is no attachment deviation of the in-vehicle sensor 30, and if equal to or greater than the threshold, it is determined that there is attachment deviation.

The pattern of the reflected light from the white line R in front of the vehicle 1 varies depending on various conditions of the road such as the shape of the white line R and an inter-vehicle distance, and thus is not necessarily obtained appropriately. Therefore, more accurate information on the white line R can be acquired due to an irradiation pattern Q obtained with a linear light beam. In addition, since the first light beam irradiation devices 21 are normally a pair of right and left, the accuracy of information on the position and angle of the white line R captured by the camera 10 (the front camera 11) is improved.

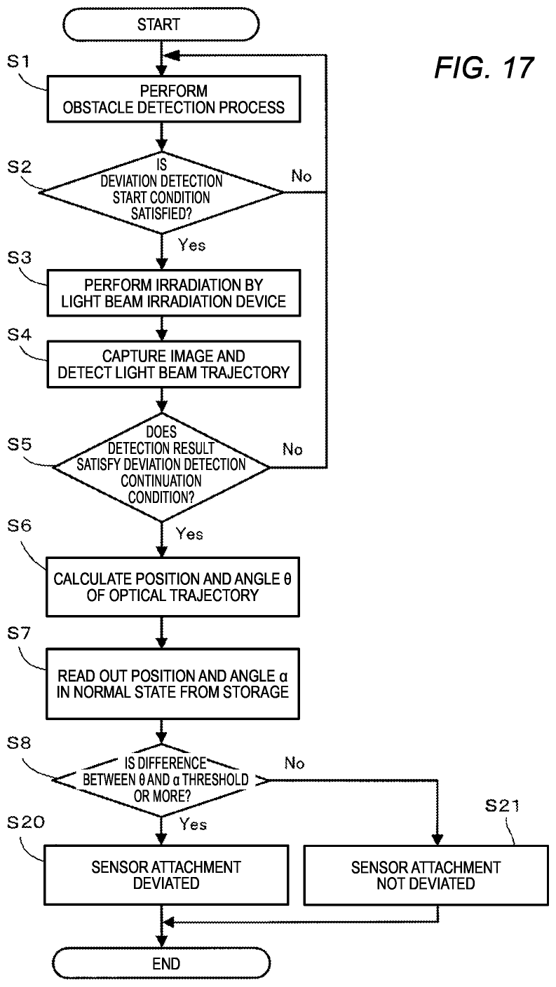

FIG. 17 is a flowchart showing the determination of the attachment deviation of the in-vehicle sensor 30. An example of the attachment deviation determination of the in-vehicle sensor 30 will be described with reference to FIG. 17.

The obstacle recognizer 54 performs an obstacle detection process based on the image captured by the camera 10 (step S1). The obstacle detection process is a step of determining whether an object that may block the light beam is detected within a predetermined distance from the camera 10, and corresponds to a basic execution condition as a basic premise in a subsequent determination of whether a deviation detection start condition is satisfied (step S2).

However, if the attachment deviation detection of the in-vehicle sensor 30 is performed each time the basic condition is satisfied, the attachment deviation detection process of the in-vehicle sensor 30 is frequently executed, which may adversely affect the life of the light beam irradiation device 20 or the like. Here, the following additional conditions may be added to the basic execution condition as the deviation detection start condition of step S2.

(1) Execution conditions: conditions related to timing, situation, and the like under which it is preferable to perform detection.

a. Within a predetermined time immediately after the vehicle 1 is started (ignition on, etc.)

b. After elapse of a predetermined time from execution of previous deviation detection

c. Immediately after an impact is applied to the vehicle 1

d. When an image of an object is captured within a predetermined distance from the camera 10 (possibility of collision)

e. When an object is detected within a predetermined distance from the in-vehicle sensor 30 (possibility of collision)

(2) Non-execution conditions: conditions related to timing, situation, and the like under which it is preferable to not perform detection.

a. Steering at a predetermined angle or more (the light beam is likely to travel in a direction in which an obstacle is present, and it is difficult to obtain a stable optical trajectory)

b. A slope present at a predetermined distance ahead (the light beam irradiation device 20 and the in-vehicle sensor 30 may be inclined)

c. When the road surface is bumpy (the road surface condition is poor and it is difficult to obtain a stable optical trajectory)

d. When the road surface is wet (the road surface condition is poor and it is difficult to obtain a stable optical trajectory)

e. When the road surface is covered with snow (the road surface condition is poor and it is difficult to obtain a stable optical trajectory)

In the attachment deviation determination of the in-vehicle sensor 30 in the sensor system 39 of the present embodiment, it is determined based on the optical trajectory that the attachment deviation of the light beam irradiation device 20=the attachment deviation of the in-vehicle sensor 30. Therefore, it is assumed that the deviation of the camera 10 basically does not occur or can be corrected using a well-known technique.

When it is determined that any deviation detection start condition is satisfied (Yes in step S2), the light beam irradiation device 20 is turned on to radiate a light beam (step S3). When it is determined that no deviation detection start conditions are satisfied (No in step S2), the deviation detection is not performed. For example, in a case where the camera 10 captures an image of an object that is present within a predetermined range of distance from the camera 10 and that is likely to block the light beam, the detection circuit 52 does not perform the determination output of the attachment deviation.

Next, an image of a light beam trajectory of the light beam is captured by the camera 10, and is detected by the light beam detector 53 (step S4). Then, information detected by the light beam detector 53 is sent to the detection circuit 52, and the detection circuit 52 determines whether the detection result satisfies a deviation detection continuation condition (step S5).

The determination in step S5 is performed based on whether a length of the detected optical trajectory (optical pattern, light beam trajectory) is equal to or greater than a predetermined length. When the size of the optical trajectory is larger than a predetermined threshold (Yes in step S5), the detection circuit 52 calculates a position and an angle θ of the optical trajectory (for example, the white line R) (step S6).

When the size of the optical trajectory is smaller than the predetermined threshold (No in step S5), the detection circuit 52 does not perform determination output of the attachment deviation starting from step S6.

However, in the case of detecting the optical trajectory, since the optical trajectory is reflection from the object and thus may be likely to be affected by external factors, the condition may be made strict, and whether a degree of coincidence (likelihood) between the size (length) of the detected optical trajectory and the size (length) of a template prepared in advance (for example, a template of a white line on a road) is equal to or greater than a predetermined value may be added to the condition (the condition is satisfied as long as the degree of coincidence is equal to or greater than the predetermined value).

Further, in the case of detecting the light beam trajectory, since the light beam trajectory is basically a trajectory of a light beam traveling in the air and is unlikely to be affected by external factors, the condition may be set looser than the optical trajectory, and the condition may be set to be whether a length a the line segment of the detected light beam trajectory is equal to or less than a predetermined value (for example, the condition is satisfied as long as the optical trajectory of the laser light traveling straight is equal to or more than the predetermined length).

Next, the detection circuit 52 reads out a position and an angle α in a normal state like a template from the storage 51 (step S7), and performs determination output of the attachment deviation of the in-vehicle sensor 30. That is, it is determined whether a difference between the angle α and the angle θ is equal to or greater than a threshold (step S8).

In a situation where the detection circuit 52 is performing the determination output of the attachment deviation, when the size of the optical trajectory becomes smaller than a predetermined threshold, the detection circuit 52 interrupts the determination output of the attachment deviation. As a result, it is possible to prevent erroneous determination of the determination output.

When the detection circuit 52 determines that the difference between the angle α and the angle θ is equal to or larger than the threshold (Yes in step S8), the detection circuit 52 determines that attachment deviation occurs to the in-vehicle sensor 30 (step S20). When the detection circuit 52 determines that the difference between the angle α and the angle θ is not equal to or larger than the threshold (No in step S8), the detection circuit 52 determines that attachment deviation does not occur to the in-vehicle sensor 30 (step S21).

Since the optical trajectory is detected from the image captured by the camera 10 and compared with the template or the like stored in the storage 51 so as to determine the attachment deviation of the in-vehicle sensor 30, it is possible to detect the attachment deviation (optical axis deviation) of the in-vehicle sensor 30 at low cost without impairing the determination accuracy of the attachment deviation determination output.

Although the attachment deviation determination output of the in-vehicle sensor 30 has been described focusing on the first in-vehicle sensors 31, the same applies to the second in-vehicle sensors 32 and the third in-vehicle sensors.

FIG. 18 illustrates a method for detecting the attachment deviation of the second in-vehicle sensors 32 that detect the rear and a corner side of the vehicle 1. The side camera 13 is attached to or integrated with the door mirror 4. The detection circuit 43 uses irradiation by the third light beam irradiation device 23 that irradiate the lateral side of the vehicle 1 and the second light beam irradiation device (for example, tail lamp) 22 that irradiates the rear of the vehicle 1 to detect an optical trajectory of a light beam captured by the side camera 13 (for example, the white line R), and performs determination output of attachment deviation of the second in-vehicle sensor 32. A detection range T of the second in-vehicle sensor 32 is indicated by a broken line surrounded in FIG. 18.

According to the above disclosure, since the camera attachment deviation determination output is performed based on the optical trajectory of the light beam captured by the in-vehicle sensor, it is possible to reduce the number of mounted inclination angle sensors and to detect the optical axis deviation of the in-vehicle sensor at low cost without impairing the determination accuracy. In addition, since the predetermined threshold is provided for the optical trajectory, it is possible to prevent erroneous determination.

An embodiments of the sensor system and the vehicle have been described above with reference to the drawings, but the present embodiment is not limited thereto. It will be apparent to those skilled in the art that various alterations, modifications, substitutions, additions, deletions, and equivalents can be conceived within the scope of the claims, and it should be understood that such changes also belong to the technical scope of the present disclosure.

### Summary of Embodiment 2

Embodiment 2 has the following features.

(Feature 1)

A sensor system mountable on a vehicle body of a vehicle, the sensor system including:

a camera configured to capture an image;

a light beam irradiation device configured to perform irradiation of a light beam; and

an in-vehicle sensor integrally attached to the light beam irradiation device and configured to radiate waves to measure at least a distance to an irradiation object;

a detection circuit configured to detect an optical trajectory of the light beam captured by the camera and determine an attachment deviation of the in-vehicle sensor based on the optical trajectory,

wherein if a size of the optical trajectory is smaller than a predetermined threshold, the detection circuit does not perform determination output of the attachment deviation.

(Feature 2)

The sensor system according to Feature 1,

wherein in a situation where the detection circuit is performing the determination output of the attachment deviation, if the size of the optical trajectory becomes smaller than a predetermined threshold, the detection circuit interrupts the determination output of the attachment deviation.

(Feature 3)

The sensor system according to Feature 1 or 2,

wherein in a case where the camera captures an image of an object that is present within a predetermined range of distance from the camera and that is likely to block the light beam, the detection circuit does not perform the determination output of the attachment deviation.

(Feature 4)

The sensor system according to any one of Features 1 to 3,

wherein the optical trajectory is an optical pattern that is a pattern of a reflected light obtained by irradiating an irradiation object with the light beam.

(Feature 5)

The sensor system according to any one of Features 1 to 3,

wherein the optical trajectory is a light beam trajectory that is a trajectory through which the light beam passes.

(Feature 6)

The sensor system according to any one of Features 1 to 5,

wherein the in-vehicle sensor is at least one of a LIDAR, a millimeter wave radar, and a sonar.

(Feature 7)

The sensor system according to any one of Features 1 to 6,

wherein the camera is at least one of: a front camera attached to a front side of the vehicle body; and a side camera attached to a lateral side of the vehicle body.

(Feature 8)

A vehicle including the sensor system according to any one of Features 1 to 7.

Although the various embodiments are described above with reference to the drawings, it is needless to say that the present disclosure is not limited to such examples. It will be apparent to those skilled in the art that various changes and modifications may be conceived within the scope of the claims. It is also understood that the various changes and modifications belong to the technical scope of the present disclosure. Constituent elements in the embodiments described above may be combined freely within a range not departing from the spirit of the present invention.

The present application is based on Japanese Patent Application (Japanese Patent Application No. 2018-214490) filed on Nov. 15, 2018, and contents thereof are incorporated herein by reference. Further, the present application is based on Japanese Patent Application (Japanese Patent Application No. 2018-216010) filed on Dec. 27, 2018, and contents thereof are incorporated herein by reference.

The camera system and the vehicle of the present disclosure are useful in a field that requires detection of camera attachment deviation at low cost. Further, the sensor system and the vehicle of the present disclosure are useful in a field that requires detection of in-vehicle sensor attachment deviation at low cost.

1. A camera system mountable on a vehicle body of a vehicle, the camera system comprising:
a camera;
a light beam irradiation device;
a processor; and
a memory having instructions that, when executed by the processor, cause the processor to perform operations comprising:
detecting an optical trajectory of a light beam from the light beam irradiation device and captured by the camera; and
determining an attachment deviation of the camera based on the optical trajectory,
wherein if a size of the optical trajectory is smaller than a predetermined threshold, determination output of the attachment deviation is not performed.

2. The camera system according to claim 1,
wherein the operations further comprises interrupting the determination output of the attachment deviation if the size of the optical trajectory becomes smaller than a predetermined threshold in a situation where the determination output of the attachment deviation is being performed.

3. The camera system according to claim 1,
wherein in a case where an image captured by the camera contains an object that is present within a predetermined range of distance from the camera and that is likely to block the light beam, the determination output of the attachment deviation is not performed.

4. The camera system according to claim 1,
wherein the optical trajectory comprises an optical pattern that is a pattern of a reflected light obtained by irradiating an irradiation object with the light beam.

5. The camera system according to claim 1,
wherein the optical trajectory comprises a light beam trajectory that is a trajectory through which the light beam passes.

6. The camera system according to claim 1,
wherein the camera comprises at least one of: a front camera attached to a front side of the vehicle body; a rear view camera attached to a rear side of the vehicle body; and a side camera attached to a lateral side of the vehicle body.

7. The camera system according to claim 6,
wherein the camera comprises the rear view camera and the side camera, and
wherein the operations further comprise comparing the optical trajectory of the light beam captured by the rear view camera with the optical trajectory of the light beam captured by the side camera to determine the attachment deviation of the camera.

8. The camera system according to claim 1,
wherein the operations further comprise obtaining a degree of coincidence between the size of the optical trajectory and a size of a template, and
wherein if the degree of coincidence is smaller than a threshold, the determination output of the attachment deviation is not performed.

9. The camera system according to claim 1,
wherein the operations further comprise:
calculating an angle of the optical trajectory;
calculating a difference between the angle of the optical trajectory and an angle in a normal state; and
determining that the attachment deviation of the camera occurs if the difference is equal to or larger than a threshold; and
determining that the attachment deviation of the camera does not occur if the difference is smaller than a threshold.

10. A vehicle comprising the camera system according to claim 1.

11. A sensor system mountable on a vehicle body of a vehicle, the sensor system comprising:
a camera;
a light beam irradiation device;
an in-vehicle sensor integrally attached to the light beam irradiation device;
a processor; and
a memory having instructions that, when executed by the processor, cause the processor to perform operations comprising:
detecting an optical trajectory of a light beam from the light beam irradiation device and captured by the camera; and
determining an attachment deviation of the in-vehicle sensor based on the optical trajectory,
wherein if a size of the optical trajectory is smaller than a predetermined threshold, determination output of the attachment deviation is not performed.

12. The sensor system according to claim 11,
wherein the operations further comprises interrupting the determination output of the attachment deviation if the size of the optical trajectory becomes smaller than a predetermined threshold in a situation where the determination output of the attachment deviation is being performed.

13. The sensor system according to claim 11,
wherein in a case where an image captured by the camera contains an object that is present within a predetermined range of distance from the camera and that is likely to block the light beam, the determination output of the attachment deviation is not performed.

14. The sensor system according to claim 11,
wherein the optical trajectory comprises an optical pattern that is a pattern of a reflected light obtained by irradiating an irradiation object with the light beam.

15. The sensor system according to claim 11,
wherein the optical trajectory comprises a light beam trajectory that is a trajectory through which the light beam passes.

16. The sensor system according to claim 11,
wherein the in-vehicle sensor comprises at least one of a LIDAR, a millimeter wave radar, and a sonar.

17. The sensor system according to claim 11,
wherein the camera comprises at least one of: a front camera attached to a front side of the vehicle body; and a side camera attached to a lateral side of the vehicle body.

18. The sensor system according to claim 17,
wherein the light beam irradiation device is provided to face rearward of the vehicle;
wherein the attachment deviation of the in-vehicle sensor is determined based on an optical trajectory captured by the side camera.

19. The sensor system according to claim 11,
wherein the operations further comprise obtaining a degree of coincidence between the size of the optical trajectory and a size of a template, and
wherein if the degree of coincidence is smaller than a threshold, the determination output of the attachment deviation is not performed.

20. The sensor system according to claim 11,
wherein the operations further comprise:
calculating an angle of the optical trajectory;
calculating a difference between the angle of the optical trajectory and an angle in a normal state;
determining that the attachment deviation of the in-vehicle sensor occurs if the difference is equal to or larger than a threshold; and
determining that the attachment deviation of the in-vehicle sensor does not occur if the difference is smaller than a threshold.
